(19) United States
(12) Patent Application Publication
(10) Pub. No.: US 2004/0212257 A1
(43) Pub. Date: Oct. 28, 2004

(54) Presenting a written and diagram discription of a free energy electric motor

(76) Inventor: William Bernard Mello, Palacios, TX (US)

Correspondence Address: William Bernard Mello, P.O. Box 1142, Talent, OR, 97540, US

(21) Appl. No.: 10/365,094

(22) Filed: Apr. 25, 2003

(51) Int. Cl. H02K 37/00

(52) U.S. Cl. 310/46

(57) ABSTRACT

Presenting a free energy electric motor that is a motor that produces much greater power than it uses to run it, because the armature has no magnetic coil windings where it is comprise only of iron and is motored by a timed sequence of intermitting electrical excitation of the stator magnetic coils. Consequently it has no ability to generate electricity while motoring thus having no resistance. (unlike all other electric motors use coil winding on the armature.) This enables the armature to ultimately reach light speed, being the known speed electrons travel. Having this motor in the environment where it can reach this speed. Its power output versus the input power will be enormously greater. E=Mc². Even having the motor in a gravity environment, great enough speed could be sustained to arrive at power outputs being many times greater than the input power. Thus arriving at free energy.

### CROSS-REFERENCE TO RELATED APPLICATIONS

“NOT APPLICABLE”

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISC APPENDIX

“NOT APPLICABLE”

### BACKGROUND OF INVENTION

Field of endeavor pertaining to electric motors.

Classification definition under FREE ENERGY MOTORS.

Relating references “NOT APPLICABLE”

Invention drawn toward eliminating electro magnetic

Resistance on the armature.

### BRIEF SUMMARY OF THE INVENTION

A free energy motor meaning that it's delivery of power versus the input supply power is greater in value. This is achieved by eliminating electro magnetic resistance on the motors armature, by having the armature solely comprised of common magnetic iron laminates or solid iron and having no magnetic coil wire windings. The common practice being iron laminates because it produces greater efficiency. Thus I will refer the armature as being made of iron laminates only in the following text.

Because the said armature having no magnetic coil windings renders it having no ability to electrically gererate while being motored thus having no resistance. Having a timed sequence of intermitting electrical excitation of the stator coils. It arrives at motoring the armature to an ultimate potential speed of its outside perimeter to reach light speed, being 186,000 miles per second, because this is the known constant speed of electron travel. Naturally this could only be achieved in a non gravitational field do to enormous centrifugal forces on the armature that iron laminate nor any known material could sustain. However the motors speed can be regulated and in a gravitational field such as here on earth the motor will still be capable of reaching great enough speed to deliver free energy power levels. The potential power being the magnetic force times velocity squared.

### BRIEF DESCRIPTION OF THE SEVERAL VIEWS OF THE DRAWINGS.

(Diagram FIG. 1) Is an overall general profile of the motor and showing a mechanical cam switch No. 5 for the stator coils and a mechanical starter No. 7.

(Diagram FIG. 2) Indicating the interior only and showing a laser switch No. 5 and its counter part No. 6.

(Diagram FIG. 3) Indicating the detail of the mechanical cam operated switch type.

(Diagram FIG. 4) Indicating detail of a commutator design switch.

(Diagram FIG. 5) And

FIG. 6 indicating two different mechanical starters.

(Diagram FIG. 7) Indicating cross sectional view of the armature No. 1, Having two opposed stator field cores No. 3, and their coil wire winding placement No. 2.

(Diagram FIG. 8) Indicating a claimed dual opposing stator and coil profile and configuration with the claimed armature.

Diagram FIG. 9) Indicating a claimed centralized singular stator and dual opposing armature motor configuration, synchronously joined by gear, chain or other.

### DETAILED DESCRIPTION OF THE INVENTION

In the diagrams presented in FIG. 1 No. 1 and FIG. 7 shows the motor armature No. 1 comprised of iron laminates seated between two stator coils No. 2 and the iron laminate stator fields No. 3.

By way of a switching method the stator coils are excited with electric current in a timing sequence of on and off. When the armature is in position the switch excites the stator coils thus creating and electro magnetic force through the stator laminat cores No. 3 thus causing a pull of magnetic attraction on the armature, torqueing it towards the stator cores radial center. This position indicated in (Diagram FIG. 7). After reaching said center the stator coils are switched off and the armature continues to rotate through momentum of acceleration until it reaches the position for the next power cycle. Thus motoring is acquired.

Starting with (Diagram FIG. 2) in an interior view showing the armature No. 1 between two stators fields No. 3 having two laser switches No. 5 and No. 6 that would be affixed on each end inside the motor housing, not shown. (Housing indicated on (Diagram FIG. 1) No. 6) positioned for the armature timing where the laser beam (Diagram FIG. 2) No. 7 emitting from sender No. 6 passes across to the mating receiver end No. 5 as the armature moves into position for the power cycle it obstructs the laser beam and the receiver No. 5 is switched on making the connection for the supply current to pass into the stator coils, thus creating the magnetic force and driving the armature. When the armature has reached full travel of the power cycle the laser beam is cleared where the sender No. 6 contacts the receiver No. 5 and the current is switched off. Thus the cycle is repeated and motoring is acquired.

In (Diagram FIG. 3) indicates a mechanical momentary switch that is controlled by an offset cam lobe No. 1 affixed to the motor shaft No. 2 (see also Diagram FIG. 1 No. 5 of assembly view) A cam follower roller (Diagram FIG. 3) No. 3 that is pushed upon by the cam lobe No. 1 and being connected to a bar member No. 9 thus connecting to the throw switch No. 4 pushing it between to metal contact bars No. 5 thus bridging the coil wires No. 6 and 7 that are affixed to said bars. The bars being separated by nonconductive members No. 8 and the assembly affixed to an outer casing. See assembly in (Diagram FIG. 1) No. 5. Upon release of the switch during rotation of the motor the switch is returned to the off position by way of a spring (Diagram FIG. 3) No. 10 thus the momentary switching is repeated to arrive at motoring the armature.

In (Diagram FIG. 4) indicates the use of a brush and commutator switch where upon rotation of the motor shaft No. 4 a laminat of a high electrical conductor No. 5 and 6 known as a commutator reach the point at the power cycle where it bridgeds two brush contacts No. 7 riding on the shaft No. 4 being held in a mount No. 10 that is affixed inside the motor housing, thus sending current to the stator coils momentarily during the power cycle and in rotation proceeding to a non electric conductor area No. 9 thus acquiring the repeating on off cycle for motoring.

In the event of regulating the motor speed. When the stator switch is off at the end of the power cycle a small designated amount of current would be maintained in the stator coils. This will create resistance or negative pull on the armatures direction as it wheelds away from the stator on the momentum cycle. So for a constant motor speed a resistor would be connected between the stator coil wires at the switch. (Diagram FIG. 3) No. 11, also a variable resistor can be used for variable speeds attached in the same position as the said constant resistor. This method of speed control would be necessary in a gravity condition were if the motors work load failed by way of breakage the motors armature would suddenly escalate twords light speed and disintegrate, rendering it hazardous, otherwise the motor could be speed controlled by varying the supply voltage.

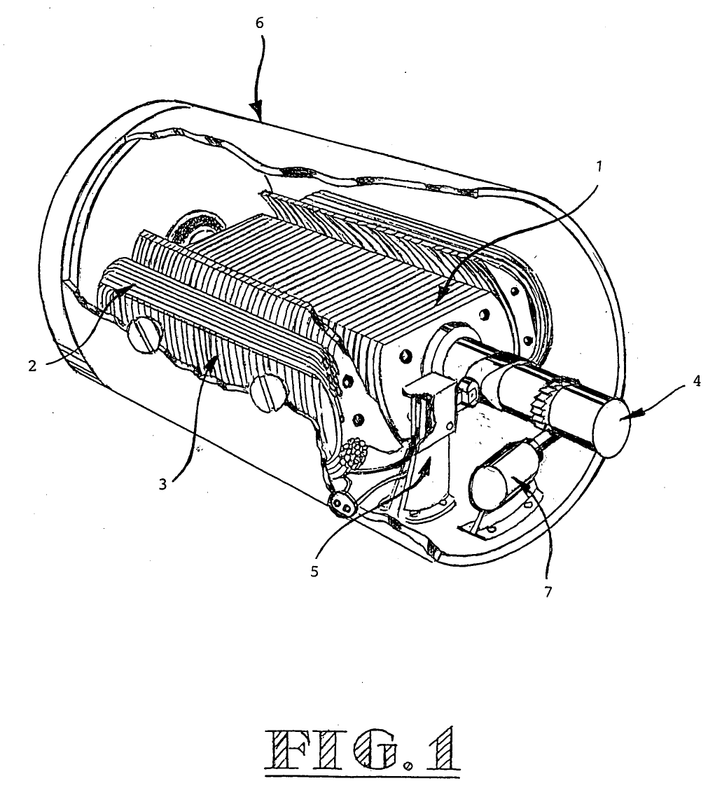

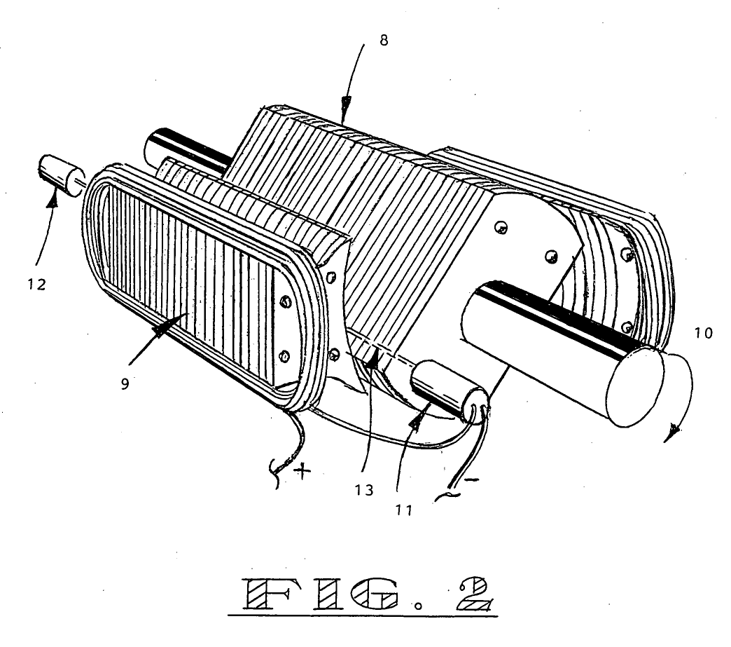

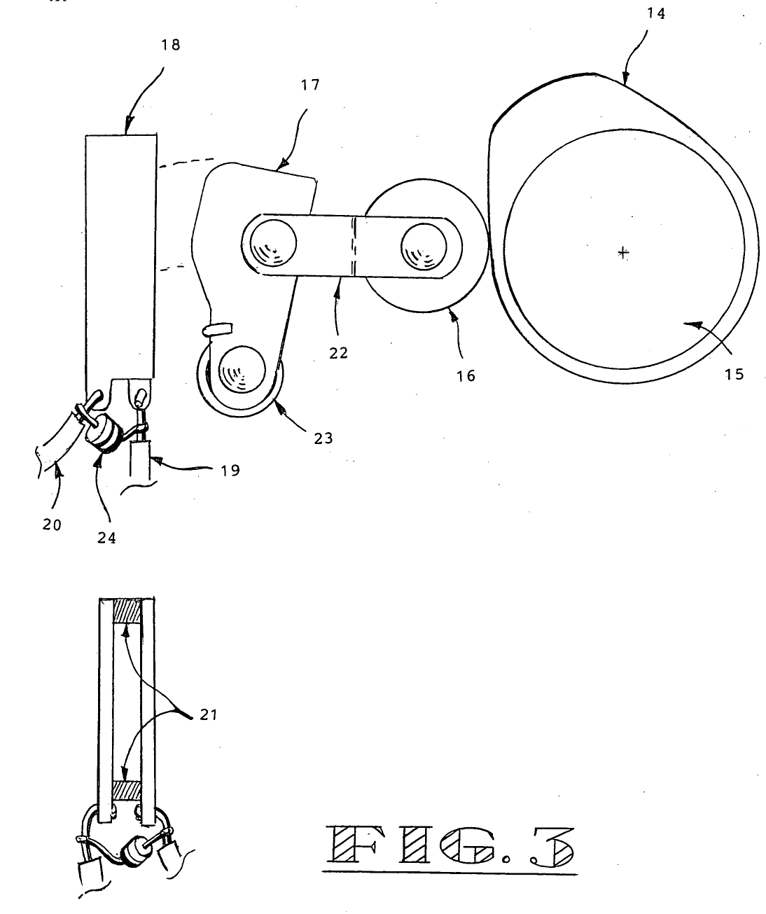

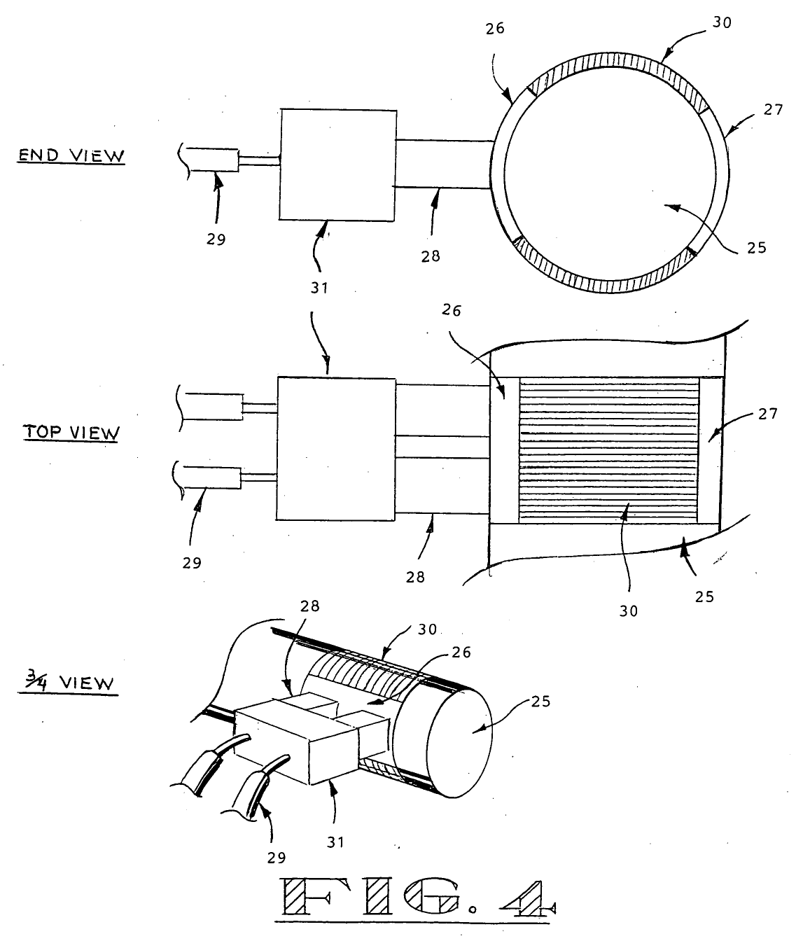

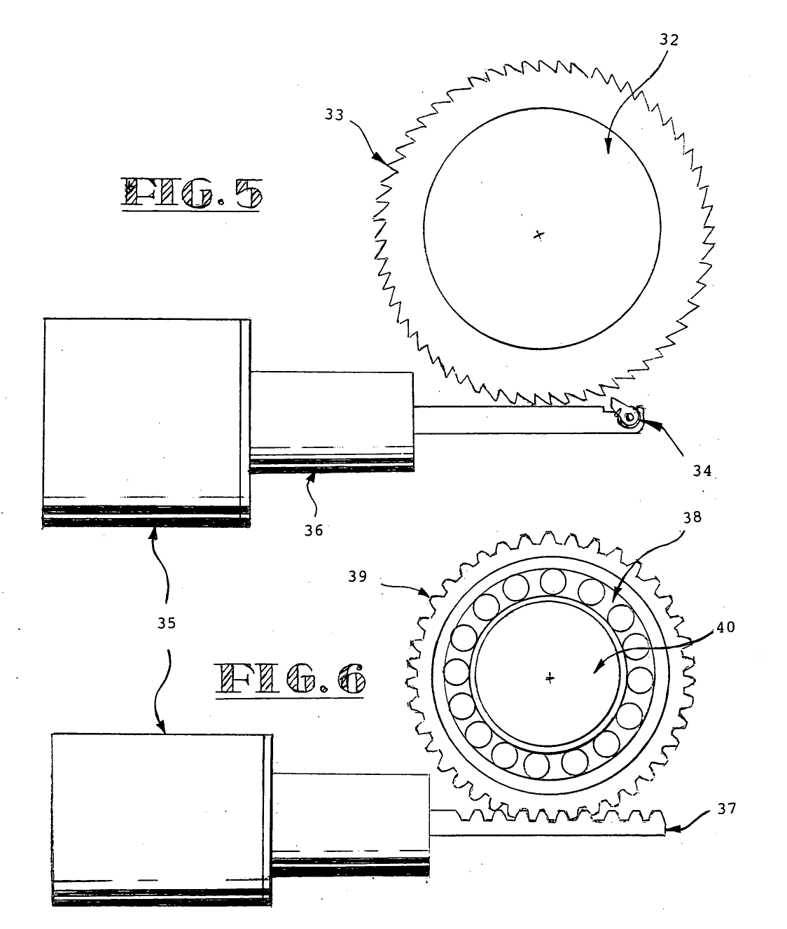

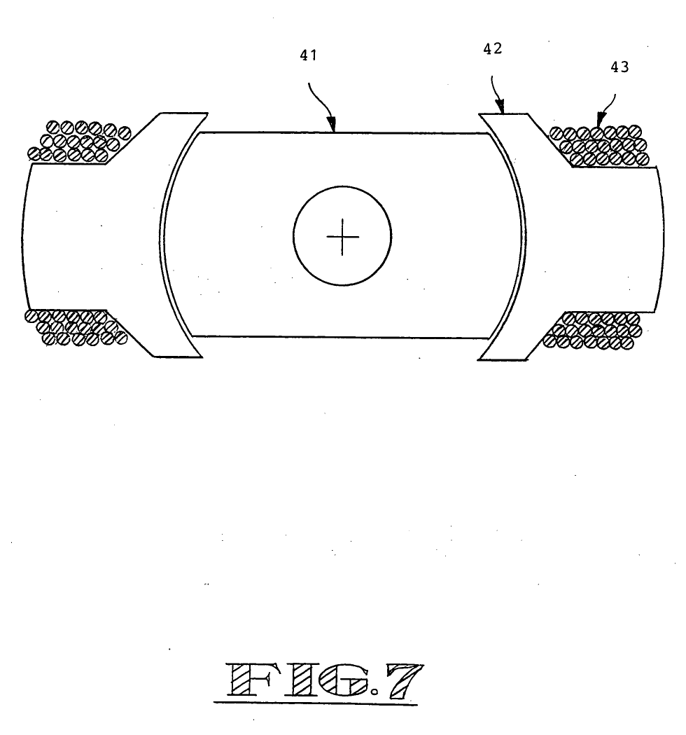

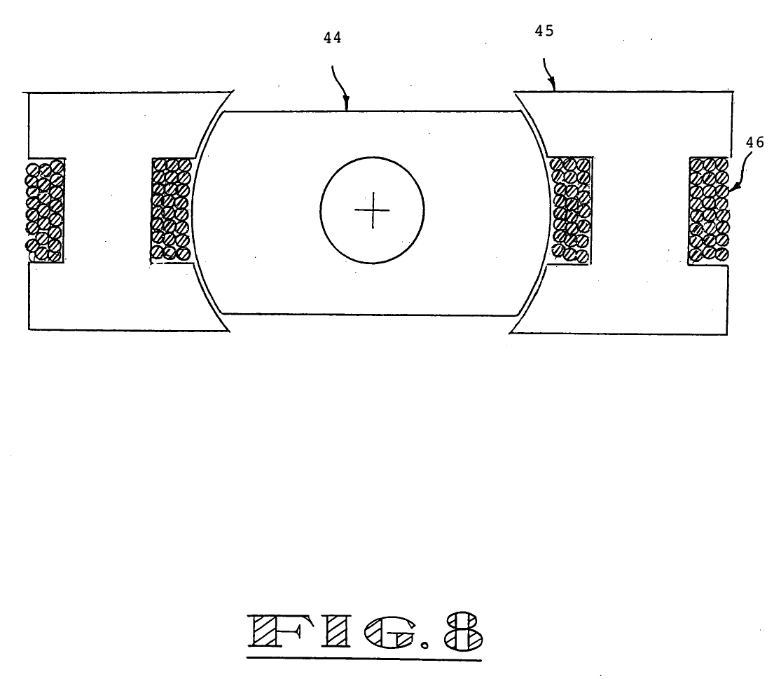

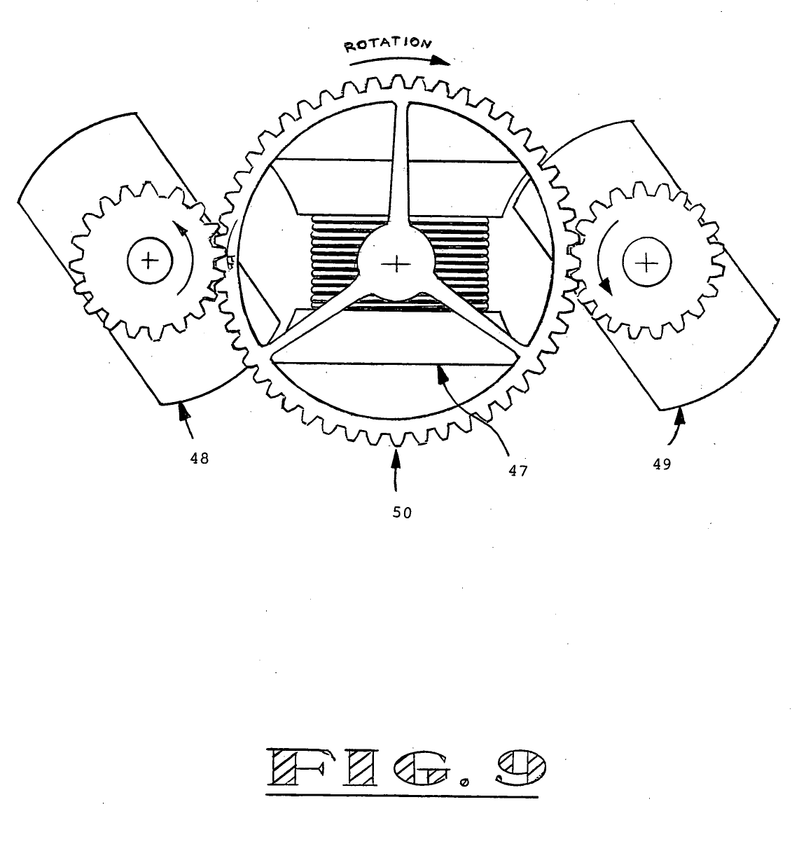

Because this motor is runned solely by the stator coils in the said manner. Instances will occur when the armature stops in the off position when the motors current supply is shut off. This requires the motor to have a mechincal means of repositioning the armature for restarting. This is achievesd by two different means in (Diagram FIG. 5) and 6. In (Diagram FIG. 5) a ratchet ring No. 5 affixed to motor shaft No. 4 (also see Diagram FIG. 1 No. 7 for assembly view) driven by a linier solenoid (Diagram FIG. 5) No. 7 has a member attacshed to the end of the solenoid plunger piston No. 8 and upon the end of the member having a spring loaded catch No. 6. When the motor is switched on from external supply, current is also delivered to the solenoid No. 7 and is engaged. Delivering a momentary linier stroke where the catch No. 6 engages with the ratchet ring No. 5 and torques the armature, moving it into position for the stator coil switch to engage thus starting the motor. The solenoid is then automatically switched off and is returned to the rest position as indicated in (Diagram FIG. 5) by way of a spring located inside the solenoid cylinder No. 9 thus the spring loaded catch No. 6 retracts to pass under the ratchet ring, where upon reaching its rest position where it remains during running of the motor. In (Diagram FIG. 6) the same action is achieved using a rack No. 1 and ring or pinion gear No. 3. The pinion gear being affixed to a standard roller clutch which is affixed to motor shaft No. 4. The roller clutch engages torque in one direction and rolls free like a bearing in the opposite direction. Thus accomplishing the same starter action as in the said ratchet design.

In (Diagram FIG. 8) No. 1 indicates the same armature as the motor in (Diagram FIG. 7) and FIG. 1. However in (Diagram FIG. 8) having a different field iron laminate profile No. 3 and Stator coil No. 2. It's position being transverse to the motors radial length. The laminate poles No. 3 paralleling each other from top and bottom of the coils north and south pole. This configuration concentrates the flux field between and within the laminate poles thus generating greater magnetic forces. Having a motor of equal size and amperage use it will deliver greater torque.

Taking this motor further, where the same torque can be achieved with only half the current use, giving it one hundred percent gain in efficiency. The realization that a stator coil generates the same magnetic force on both sides of its poles. As is the flux field of all magnetism being symmetrical. By placing one stator, (Diagram FIG. 9) No. 1 in the center of two armatures, No. 2 and No. 3, each armature is being motored on one half it's diameter at a time. Equaling the same torque as one armature being motored by two stators on each side, as in conventional method. The difference being only one stator coil is being used instead of two, thus only half the current used. This can be with both stator field designs presented in (Diagrams FIG. 7) and FIG. 8. In (Diagram FIG. 9) No. 4 indicates the two armatures joined on one end with gears to a center output shaft. The gears would then regulate the synchronous timing required to run the two armatures. The two armature shafts can also be joined with chain or a timing belt having one armature shaft longer as to be the output drive shaft, not shown in diagram.

This concludes all aspects necessary for understanding the working of this Free Energy Electric Motor and is compliant to Einstein's Equation that energy equals mass times velocity squared.

What I claim as my invention is a free energy electric motor:

1; A SOLID IRON LAMINATE ARMATURE, having no magnetic coil windings.

2; One of two, STATOR COIL and FIELD IRON LAMINATE profile and configuration. Described in Diagram FIG. 8.

3; ELECTRICAL MOMENTARY SWITCHING OF STATOR COILS, for motoring the armature.

4; A DUAL ARMATURE and SINGLE STATOR MOTOR configuration.

5; ELECTRICAL RESISTIVE MOTOR SPEED CONTROL.

6; TWO MACHANICAL STARTERS.
